(19) United States
(12) Patent Application Publication
(10) Pub. No.: US 2008/0205339 A1
(43) Pub. Date: Aug. 28, 2008

(54) Auto-Provisioning of a Mobile Computing Device for Operation With A Wireless Network

(75) Inventor: Timothy J. Brophy, Schwenksville, PA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/680,215

(22) Filed: Feb. 28, 2007

(51) Int. Cl. H04Q 7/00

(52) U.S. Cl. 370/331

(57) ABSTRACT

An automatic provisioning methodology for a mobile computing device in a wireless network is disclosed herein. The mobile computing device can support open communication with a wireless switch, which is configured to function as a load request proxy between the mobile computing device and a mobile services system on the wireless network. The mobile services system sends provisioning data to the wireless switch (using secure communications), which in turn sends the provisioning data to the mobile computing device. The mobile computing device can then use the provisioning data to configure its software applications, security settings, and the like.

### TECHNICAL FIELD

Embodiments of the subject matter described herein relate generally to mobile computing devices and related wireless network infrastructure. More particularly, embodiments of the subject matter relate to automatic provisioning and configuring techniques for mobile computing devices.

### BACKGROUND

The prior art includes mobile computing devices, including general purpose devices and devices that are designed to perform specific functions. Mobile computing devices intended for industrial, retail, shipping, and inventory applications are typically designed to be rugged, robust, and weatherproof. Mobile computing devices, such as portable scanning devices and RFID readers, are available from manufacturers such as Symbol Technologies, Inc. These mobile computing devices are usually designed with wireless data communication features that allow them to communicate with a wireless network, e.g., a wireless local area network (WLAN).

WLANs rely on WLAN infrastructure components that establish data communication links with mobile client devices. A mobile client device communicates, via a wireless data communication channel, with an access point or access port device, which in turn communicates with other network components via traditional wired interfaces. This generally involves the use of wireless access devices that communicate with the mobile client devices using one or more RF channels (e.g., in accordance with one or more of the IEEE 802.11 standards).

A WLAN may also include wireless switches as needed. A wireless switch generally functions as a centralized control point for wireless and RF compliant devices within a data communication network. Wireless switches can be utilized in RFID and scanning systems that support one or more mobile computing devices. Moreover, a WLAN infrastructure may be configured to support a plurality of “virtual” or “logical” WLANs using a single access device. In other words, one access device can support a plurality of logical WLANs, which may be accessed by different groups or categories of client devices.

A new “out of the box” mobile computing device may be configured as a generic device that lacks the specific configuration data, software applications, security settings, and possibly other data necessary for compatible operation with the intended wireless network infrastructure and wireless network applications. Traditional techniques for configuring or provisioning a new mobile computing device rely on somewhat cumbersome, time consuming, or user-involved procedures. For example, one conventional technique for provisioning a new mobile computing device involves the scanning of bar codes (with the mobile computing device itself) as a preliminary configuration step. Thereafter, the mobile computing device can access the wireless network in a secure manner and download additional provisioning data as needed. Another conventional technique for provisioning a new mobile computing device involves the manual loading of software applications, security information, and other data utilized to gain secure access to the wireless network. While such techniques may be effective for relatively small scale deployments, they can become very time consuming and inefficient for large scale applications having a large number of mobile computing devices. Moreover, existing techniques for provisioning new mobile computing devices may be susceptible to human data entry errors.

### BRIEF SUMMARY

The techniques and technologies described herein facilitate automatic provisioning of a mobile computing device for operation in a wireless network. An embodiment of the provisioning methodology requires little or no operator involvement, and the provisioning may be automatically initiated upon initial power-up of the mobile computing device. Security techniques can be implemented to prevent unauthorized access to the wireless network during provisioning. Moreover, the automatic provisioning technology described herein can be designed to remain compatible with traditional provisioning techniques supported by legacy mobile computing devices.

The above and other aspects may be carried out by an embodiment of a method for provisioning a mobile computing device for operation with a wireless network. The method involves: associating the mobile computing device with a wireless switch in the wireless network; receiving a load request from the mobile computing device; generating, in response to the load request, a proxy load request for the mobile computing device; sending the proxy load request to a mobile services system in the network; receiving, in response to the proxy load request, provisioning data for the mobile computing device; and sending the provisioning data to the mobile computing device.

The above and other features may be supported by an embodiment of a wireless network device having: a processing architecture; a memory element coupled to the processing architecture; and a communication module coupled to the processing architecture. The processing architecture and the communication module are cooperatively configured to: associate a mobile computing device in a wireless network with the wireless network device; function as a provisioning data proxy between the mobile computing device and a mobile services system in the wireless network; and send provisioning data obtained from the mobile services system to the mobile computing device in response to a load request that originates from the mobile computing device.

The above and other features may be supported by an embodiment of a wireless network architecture having: a network infrastructure; a wireless switch coupled to the network infrastructure; a mobile services system coupled to the network infrastructure; and a mobile computing device configured to associate with the wireless switch using a default network identifier that is orphaned in the wireless switch, and to send a load request to the wireless switch upon initialization. The wireless switch is configured to receive the load request, and to send, in response to the load request, a proxy load request to the mobile services system. In addition, the mobile services system is configured to provide, in response to the proxy load request, provisioning data for the mobile computing device. Moreover, the wireless switch is configured to receive the provisioning data from the mobile services system, and to send the provisioning data to the mobile computing device.

The above and other aspects may be carried out by an embodiment of a method for provisioning a mobile computing device for operation with a wireless network. The method involves: associating the mobile computing device with a wireless switch in the wireless network, using a default network identifier that is orphaned in the wireless switch; the mobile computing device sending a load request to the wireless switch; the mobile computing device receiving, in response to the load request, provisioning data from the wireless switch; and the mobile computing device configuring itself with the provisioning data for operation with the wireless network.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a wireless network configured to support automatic provisioning of mobile computing devices;

FIG. 2 is a schematic representation of an embodiment of a mobile computing device suitable for use in the wireless network shown in FIG. 1;

FIG. 3 is a schematic representation of an embodiment of a wireless switch suitable for use in the wireless network shown in FIG. 1; and

FIG. 4 is a diagram that illustrates an embodiment of a mobile device provisioning process.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments may be practiced in conjunction with any number of network architectures, data transmission protocols, and mobile computing device configurations, and that the system described herein is merely one suitable example.

For the sake of brevity, conventional techniques related to wireless signal processing, wireless data transmission, WLANs, signaling, network control, wireless switches, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

Those of skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application.

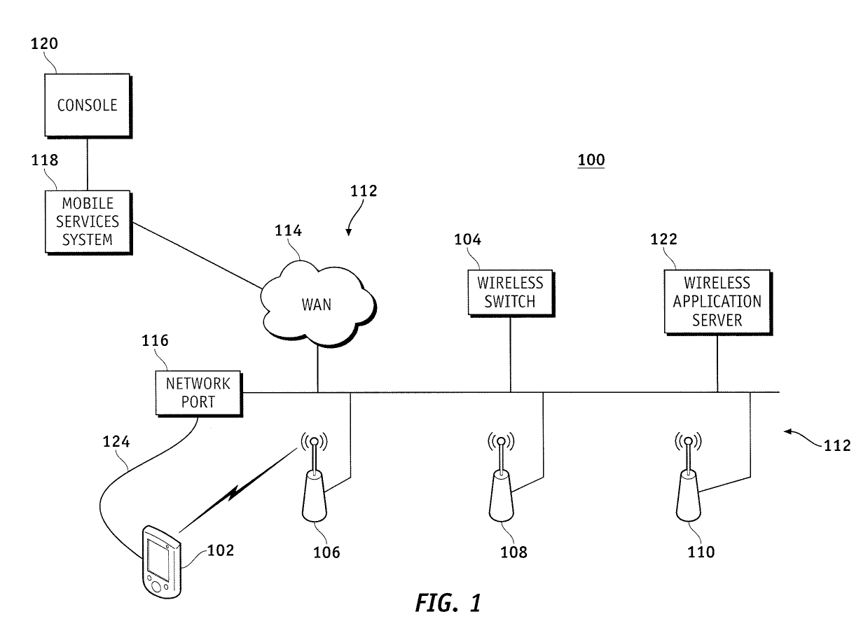

FIG. 1 is a schematic representation of an embodiment of a wireless network 100 configured to support automatic provisioning of mobile computing devices, such as a mobile computing device 102. In this example, wireless network 100 includes a WLAN. Wireless network 100 generally includes one or more wireless clients (including wireless computing device 102), a wireless switch 104, and a number of wireless access devices (identified by reference numbers 106, 108, and 110). Wireless network 100 may also include or communicate with any number of additional network components that form a network infrastructure 112, such as a traditional local area network (LAN), a wide area network (WAN) 114, or a network port 116 (which may be realized in a computer utilized in wireless network 100). Network infrastructure 112 may include cables, connectors, interfaces, and/or other components that couple together the elements of wireless network 100.

Wireless network 100 includes or communicates with a mobile services system 118, which may include or be coupled to a console 120 that serves as an operator terminal. This particular embodiment of wireless network 100 also includes a wireless application server 122 that is suitably configured to support wireless clients of wireless network 100. A practical embodiment can have any number of wireless switches, each supporting any number of wireless access devices, and each wireless access device supporting any number of wireless clients. Indeed, the topology and configuration of wireless network 100 can vary to suit the needs of the particular application and FIG. 1 is not intended to limit the application or scope of the invention in any way.

Wireless clients are mobile devices that can physically move within wireless network 100 and communicate with network infrastructure 112 via wireless access devices 106/108/110. Mobile computing device 102 is an example of a wireless client suitable for use with wireless network 100. As used herein, a “mobile computing device” refers to a portable, hand held computing device that includes at least a processor, memory, and a user interface. A mobile computing device typically includes a combination of any of the following features, without limitation: a display element; a keypad or keyboard; a touchpad; a stylus writing pad; a data capture module (e.g., a bar code scanner, an imager, a magnetic stripe reader); a WAN transceiver/antenna; a LAN transceiver/antenna; a PAN transceiver/antenna; a battery or other power supply; a GPS receiver; a data communication module; input/output connectors; and a trigger. Conventional mobile computing devices are available from Symbol Technologies, Inc. and other manufacturers. For example, the following product model numbers refer to mobile computing devices that are currently available from Symbol Technologies, Inc.: MC9000, MC3000, PDT8100, PPT8800, and MC50. Any of these mobile computing devices can be suitably configured or modified to support the automatic provisioning techniques described herein. Alternatively (or additionally), mobile computing device 102 may be realized as a personal digital assistant (PDA), a palmtop computer, a notebook computer, a laptop computer, a suitably equipped wireless telephone, or the like.

In this example, wireless access devices 106/108/110 are realized as wireless access ports, which are “thin” devices that rely on the network intelligence and management functions provided by wireless switch 104 (in contrast to a wireless access point, which is a “thick” device having the network intelligence and processing power integrated therein). Wireless access ports having conventional features that can be incorporated into wireless access devices 106/108/110 are available from Symbol Technologies, Inc. Briefly, a wireless access device as described herein is suitably configured to receive data from wireless clients over wireless data communication links. Once that data is captured by the wireless access device, the data is encapsulated for communication to wireless switch 104. For example, the data is encapsulated into a packet format compliant with a suitable data communication protocol. For this example, data is sent unicast within wireless network 100 using conventional Ethernet 802.3 addressing (including standard Ethernet destination and source packet addresses).

Wireless switch 104, which may be coupled to an Ethernet switch (not shown), communicates with wireless access devices 106/108/110. A given wireless switch can support any number of wireless access devices, i.e., one or more wireless access devices can be concurrently adopted by a single wireless switch. In this example, a wireless access device can be adopted by only one wireless switch at a time.

Wireless switch 104 is suitably configured to communicate with mobile services system 118 as described in more detail below. In this embodiment, wireless switch 104 communicates with mobile services system 118 in a secure manner using network infrastructure 112 and WAN 114. Mobile services system 118 is suitably configured to provide provisioning and/or configuration data that is utilized to provision mobile client devices such as mobile computing device 102. As described in more detail below, mobile services system 118 can send provisioning data for mobile computing device 102 to wireless switch 104, which functions as a provisioning data proxy between mobile computing device 102 and mobile services system 118. Mobile services system 118 may be implemented as one or more hardware components, and it may be designed to support any number of wireless networks for an enterprise that has physical components dispersed throughout any number of physical locations or facilities (for simplicity, FIG. 1 depicts a simplified environment where mobile services system 118 only supports wireless network 100). As one non-limiting example, the system offered by Symbol Technologies, Inc. as the Mobility Services Platform is one suitable implementation of mobile services system 118.

Mobile computing device 102 may also be configured to support data communication with network infrastructure 112 via a tangible data communication link 124 and network port 116. For example, data communication link 124 may be realized as a USB cable, and network port 116 may be realized as a USB port, connector, or interface. Of course, the specific implementation of tangible data communication link 124 and network port 116 may be selected to suit the needs of the particular deployment of wireless network 100, and the USB version described here is not intended to limit or otherwise restrict the scope or application of any practical embodiment of wireless network 100.

Briefly, the components and elements depicted in FIG. 1 are suitably configured to support the automatic provisioning techniques and technologies described in more detail below. In practice, these components and elements will also be configured to support well known features and functions that relate to conventional operating aspects of wireless network 100. Such known features, functions, and aspects will not be described herein.

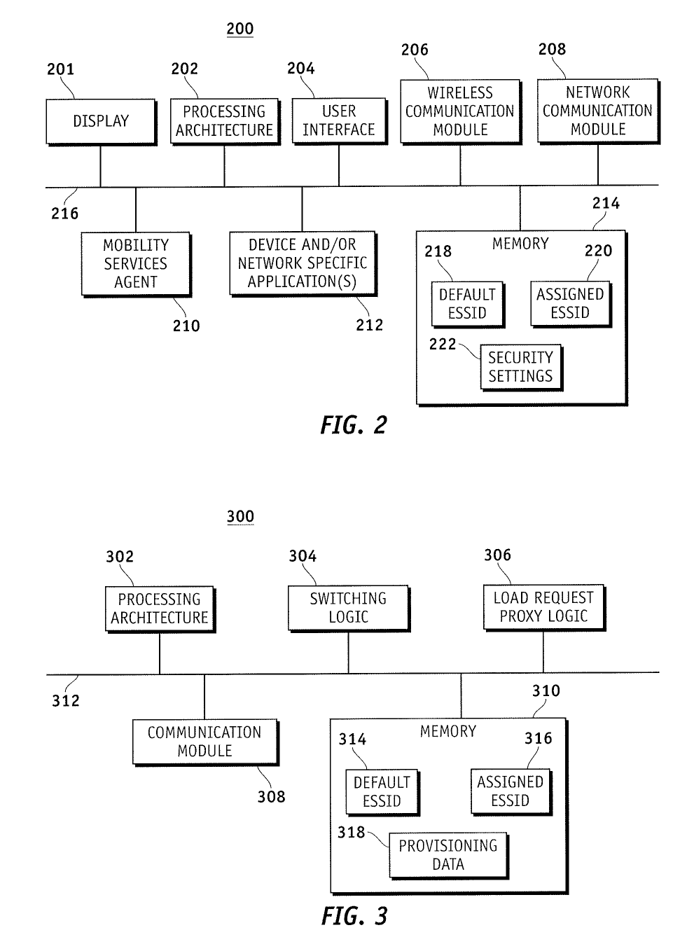

FIG. 2 is a schematic representation of an embodiment of a mobile computing device 200 suitable for use in a wireless network, such as wireless network 100 shown in FIG. 1. FIG. 2 depicts mobile computing device 200 in an oversimplified manner, and a practical embodiment will of course include many additional features and components. Mobile computing device 200 generally includes, without limitation: a display element 201; a processing architecture 202; a user interface 204 (such as a keypad and/or a touchpad); a wireless communication module 206, a network communication module 208; a mobility services agent 210; one or more device and/or network specific applications 212; and a suitable amount of memory 214. An embodiment of mobile computing device 200 may also include a number of components and suitably configured processing logic related to common features and functions that are not described in detail herein. The elements of mobile computing device 200 may be interconnected together using a bus 216 or any suitable interconnection arrangement. Such interconnection facilitates communication between the various elements of mobile computing device 200.

Processing architecture 202 may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this regard, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. In practice, processing architecture 202 includes processing logic that is configured to carry out the functions, techniques, and processing tasks associated with the operation of mobile computing device 200. In particular, the processing logic is configured to support the automatic provisioning techniques described herein.

Furthermore, the steps of a method or algorithm described in connection with the embodiments disclosed herein may be embodied directly in hardware, in firmware, in a software module executed by processing architecture 202, or in any practical combination thereof. A software module may reside in memory 214, which may be realized as RAM memory, flash memory, ROM memory, EPROM memory, EEPROM memory, registers, a hard disk, a removable disk, a CD-ROM, or any other form of storage medium known in the art. In this regard, memory 214 can be coupled to processing architecture 202 such that processing architecture 202 can read information from, and write information to, memory 214. In the alternative, memory 214 may be integral to processing architecture 202. As an example, processing architecture 202 and memory 214 may reside in an ASIC.

Display element 201 and user interface 204 function as input/output elements for the operator of mobile computing device 200. Display element 201 and user interface 204 may be coupled to one or more electronics modules (not shown) as necessary to support input/output functions in a conventional manner. In addition, display element 201 and user interface 204 may be utilized during provisioning of mobile computing device 200 to obtain instructions from the operator and/or to convey information to the operator.

Wireless communication module 206 is suitably configured to support wireless data communication for mobile computing device 200. Referring to FIG. 1, wireless communication module 206 facilitates wireless communication with network infrastructure 112 via, for example, access devices 106/108/110. Wireless communication module 206 may also be configured to support wireless communication with other devices within a wireless network. For the embodiments described herein, wireless communication module 206 is configured to support bidirectional communication between mobile computing device 200 and the wireless network infrastructure using wireless communication links. For automatic provisioning, wireless communication module 206 sends a load request to the network infrastructure via a wireless communication link, and receives provisioning data from the network infrastructure via the wireless communication link.

Wireless communication module 206 may include or be realized as a radio module that supports one or more wireless data communication protocols and one or more wireless data transmission schemes. In an embodiment of mobile computing device 200, wireless communication module 206 may include or be realized as hardware, software, and/or firmware, such as an RF front end, a suitably configured radio module (which may be a stand alone module or integrated with other or all functions of mobile computing device 200), a wireless transmitter, a wireless receiver, a wireless transceiver, an infrared sensor, an electromagnetic transducer, or the like. In practice, mobile computing device 200 may include one or more antennas coupled to wireless communication module 206. The antenna is appropriately configured in accordance with the particular design of wireless communication module 206.

Wireless communication module 206 supports one or more wireless data communication protocols that are also supported by the wireless network infrastructure. Any number of suitable wireless data communication protocols, techniques, or methodologies may be supported by wireless communication module 206, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Wireless communication module 206 is preferably compliant with at least the IEEE 802.11 specification.

Network communication module 208 is suitably configured to support data communication via a wired, cabled, or other tangible data communication link. Referring to FIG. 1, network communication module 208 facilitates wired communication with network infrastructure 112 via tangible data communication link 124 and network port 116. Although not shown, mobile computing device 200 may also be suitably configured to support wired data communication with other devices within a wireless network. For the embodiments described herein, network communication module 208 is configured to support bidirectional communication between mobile computing device 200 and the network infrastructure using a tangible data communication link, such as a USB cable. For automatic provisioning, network communication module 208 sends a load request to the network infrastructure via the tangible data communication link, and receives provisioning data from the network infrastructure via the tangible data communication link.

In practice, network communication module 208 may include interface logic and a network interface port, which may be realized as a cable connector, receptacle, jack, or plug. The interface logic may be implemented in processing architecture 202 (even though FIG. 2 depicts processing architecture 202 and network communication module 208 as separate elements). In a practical embodiment of mobile computing device 200, network communication module 208 is a USB interface, the interface logic is compatible with USB specifications and requirements, and the network interface port is a USB port or connector. Of course, alternate embodiments may utilize different network interface configurations (for example, IEEE 1394) and, therefore, different network interface connectors, ports, couplers, or the like.

For transmission of data over a cable, a wired connection, a direct connection, or other tangible link, network communication module 208 supports one or more wired/cabled data communication protocols that are also supported by the network infrastructure. Any number of suitable data communication protocols, techniques, or methodologies may be supported by network communication module 208, including, without limitation: Ethernet; home network communication protocols; USB; IEEE 1394 (Firewire); hospital network communication protocols; and proprietary data communication protocols. As mentioned above, network communication module 208 is preferably compliant with at least the USB specification.

Mobility services agent 210 represents a software application, firmware, processing logic, and/or a feature of mobile computing device 200 that enables the automatic provisioning techniques described herein. Referring to FIG. 1, mobility services agent 210 is suitably configured for compatibility with mobile services system 118. Mobility services agent 210 allows wireless switch 104 to adopt mobile computing device 200, and to function as a proxy for mobile computing device 200 for purposes of secure provisioning. Therefore, in a practical deployment, a mobile computing device that lacks mobility services agent 210 (or equivalent functionality) will not be able to take advantage of the automatic provisioning methodology described herein.

Device and/or network specific applications 212 includes one or more software applications, computer programs, or agents for mobile computing device 200. Applications 212 may be device-specific and/or network-specific, and applications 212 are utilized to provide the desired functionality and feature set to mobile computing device 200. Notably, applications 212 are one type of provisioning data that can be downloaded to mobile computing device 200 during automatic provisioning. One or more applications 212 may define the functionality of mobile computing device 200. For example, applications 212 may determine whether mobile computing device 200 functions as a telnet client, a batch device, a voice client, an RFID reader, a barcode reader, etc. One or more applications 212 may also enable mobile computing device 200 to become compatible with the particular wireless network (i.e., applications 212 can be network-specific). For example, applications 212 may allow mobile computing device 200 to become compatible with wireless application server 122 (see FIG. 1). In this regard, mobile computing device 200 may be shipped as a generic or “blank” device, and applications 212 can be provided during automatic provisioning.

Memory 214 can be utilized to store configuration data, provisioning data, settings data, and other information processed by mobile computing device 200. In this example, memory 214 may be utilized to store a default network identifier 218, an assigned network identifier 220, and security settings 222 for mobile computing device 200. Notably, the assigned network identifier 220 and security settings 222 are types of provisioning data that can be downloaded to mobile computing device 200 during automatic provisioning. In an embodiment of mobile computing device 200, the default network identifier is a default service set identifier, e.g., a default extended service set identifier (ESSID) that is shipped with the device. Likewise, the assigned network identifier may be an assigned service set identifier, e.g., an assigned ESSID. Security settings 222 are used by mobile computing device 200 when accessing the wireless network. In this regard, security settings 222 may control or determine the type and level of security to be used when mobile computing device 200 communicates with the wireless network. For example, security settings 222 may dictate whether mobile computing device 200 is to use certificates, tokens, username and password, etc.

FIG. 3 is a schematic representation of an embodiment of a wireless switch 300 suitable for use in a wireless network, such as wireless network 100 shown in FIG. 1. FIG. 3 depicts wireless switch 300 in an oversimplified manner, and a practical embodiment will of course include many additional features and components. Wireless switch 300 generally includes, without limitation: a processing architecture 302; switching logic 304; load request proxy logic 306; a communication module 308; and a suitable amount of memory 310. An embodiment of wireless switch 300 may also include a number of components and suitably configured processing logic related to common features and functions that are not described in detail herein. The elements of wireless switch 300 may be interconnected together using a bus 312 or any suitable interconnection arrangement. Such interconnection facilitates communication between the various elements of wireless switch 300.

Processing architecture 302 may be implemented and generally configured as described above for processing architecture 202 of mobile computing device 200. In practice, processing architecture 302 includes processing logic that is configured to carry out the functions, techniques, and processing tasks associated with the operation of wireless switch 300. In particular, the processing logic is configured to support the automatic provisioning techniques described herein. Processing architecture 302 may be configured to perform methods and carry out instructions, possibly cooperating with memory 310 as described above in the context of processing architecture 202 and memory 214.

Switching logic 304, which may be partially or completely realized in processing architecture 302, represents processing logic and functionality associated with the data switching and communicating features of wireless switch 300. Switching logic 304 may be configured to perform conventional operations that enable data traffic in the wireless network to be communicated between client devices (e.g., mobile computing devices), access devices, network infrastructure components, and network-based systems or applications.

Load request proxy logic 306, which may be partially or completely realized in processing architecture 302, represents processing logic and functionality associated with the handling of load requests that originate at wireless computing devices. In this regard, load request proxy logic 306 may be suitably configured to receive and process load requests generated by a mobile computing device, send a proxy load request to mobile services system 118, and receive and process provisioning data provided by mobile services system 118 (see FIG. 1). Load request proxy logic 306 may also support other features and functions of wireless switch 300 described in more detail herein.

Communication module 308 is suitably configured to support wired or wireless data communication in the wireless network. In this regard, communication module 308 may be implemented and generally configured as described above for wireless communication module 206 and/or network communication module 208 of mobile computing device 200. Communication module 308 allows wireless switch 300 to communicate with, for example, network infrastructure 112, access devices 106/108/110, and mobile services system 118.

In practice, processing architecture 302, switching logic 304, load request proxy logic 306, and communication module 308 are cooperatively configured to perform the various automatic provisioning operations described in more detail below. Notably, these elements are suitably configured to function as a provisioning data proxy between mobile computing devices and the mobile services system. In particular, communication module 308 sends provisioning data obtained from the mobile services system in response to load requests that originate from mobile computing devices.

Memory 310 can be utilized to store configuration data, provisioning data, settings data, and other information processed by wireless switch 300. In this example, memory 310 may be utilized to store a default network identifier 314, an assigned network identifier 316, and some or all of the provisioning data 318 for mobile computing devices. As mentioned previously, the default network identifier may be a default service set identifier (e.g., a default ESSID), and the assigned network identifier may be an assigned service set identifier (e.g., an assigned ESSID). Provisioning data 318 can be maintained by wireless switch 300 for any number of mobile computing devices that have been provisioned by wireless switch 300.

Referring again to FIG. 1, mobile computing device 102, a suitably configured wireless network device (such as wireless switch 104), and mobile services system 118 cooperate in a manner that supports automatic provisioning of mobile computing device 102. In accordance with an embodiment of the automatic provisioning methodology, an unloaded or “generic” mobile computing device 102 associates with wireless switch 104 using a default network identifier (e.g., a default ESSID) that is orphaned in wireless switch 104. This allows mobile computing device 102 to send a load request to wireless switch 104 upon initialization of mobile computing device 102. Wireless switch 104 receives the load request, generates a proxy load request in response to the received load request, and sends the proxy load request to mobile services system 118. In response to the proxy load request, mobile services system 118 provides provisioning data for the mobile computing device. Mobile services system 118 sends the provisioning data to wireless switch 104, which receives and processes the provisioning data and, in turn, sends the provisioning data to mobile computing device 102. Upon receipt of the provisioning data, mobile computing device 102 provisions/configures itself for operation with wireless network 100. In practice, mobile computing device 102 may reboot itself with the provisioning data and reconnect with wireless network 100 as needed.

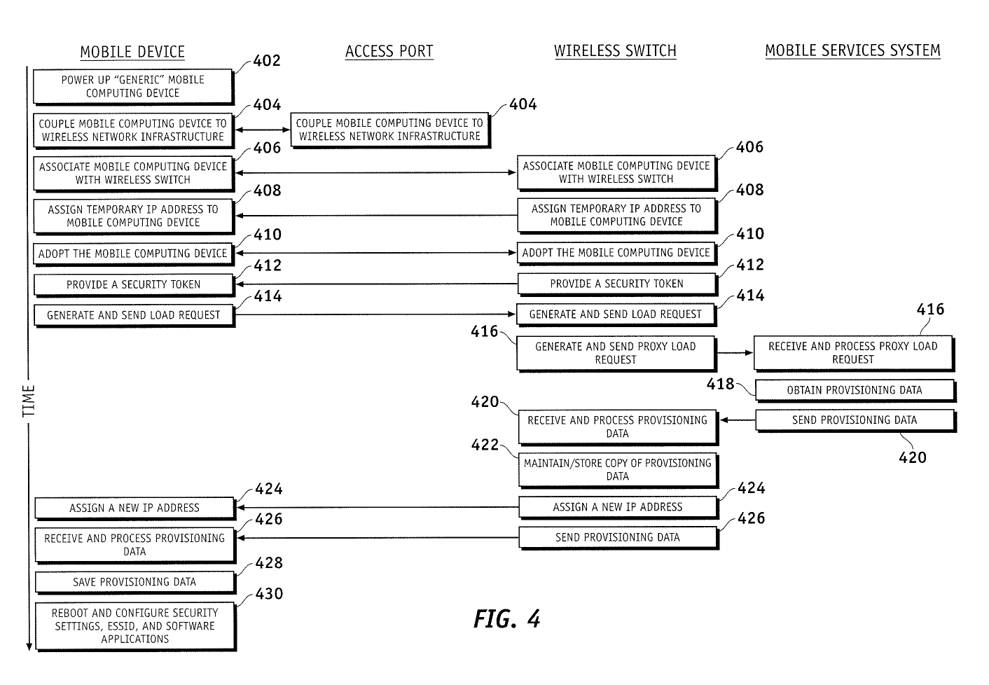

FIG. 4 is a diagram that illustrates an embodiment of a mobile device provisioning process, which may be performed when a new mobile computing device is introduced into a wireless network. FIG. 4 is a hybrid of a timing diagram and a flow chart. The various tasks performed in connection with the process may be performed by software, hardware, firmware, or any combination thereof. For illustrative purposes, the following description may refer to elements mentioned above in connection with FIGS. 1-3. In this regard, FIG. 4 depicts tasks performed by different elements of the described system, e.g., a mobile computing device, an access port, a wireless switch, and a mobile services system. It should be appreciated that an embodiment of this process may include any number of additional or alternative tasks, the tasks shown in FIG. 4 need not be performed in the illustrated order, and the process may be incorporated into a more comprehensive procedure or process having additional functionality not described in detail herein.

The automatic provisioning process begins after a “generic” mobile computing device is powered up (task 402). As used herein, a “generic” mobile computing device is one that has not yet been loaded with the applications and configuration data needed for compatible operation with the particular wireless network. A generic mobile computing device may be a new out-of-the-box unit or it may be a unit that has been reformatted and/or purged of any previous applications and configuration data. After power up, the mobile computing device may initiate the process by itself or it may initiate the process in response to an operator action or command.

Before proceeding with the provisioning process, the mobile computing device is coupled to the wireless network infrastructure (task 404). For the illustrated embodiment, task 404 involves the mobile computing device and an access port, and the mobile computing device is coupled to the network infrastructure via a wireless data communication link. Task 404 establishes the data communication path between the mobile computing device and the wireless network. Alternatively, the mobile computing device can be coupled to the network infrastructure via a tangible data communication link such as a USB cable.

Next, the mobile computing device associates with the wireless switch (task 406). This associating step may be initiated when the mobile computing device is coupled to the network infrastructure. In this example, the mobile computing device associates to a default network identifier that is orphaned in the wireless switch. The mobile computing device may broadcast an association request that contains the default network identifier, which informs the network infrastructure components that the mobile computing device is seeking a connection with an infrastructure component that supports the default network identifier. The default network identifier is not utilized for normal network operations, and the default network identifier is “orphaned” in the wireless switch in the sense that devices having the default network identifier can only communicate with the wireless switch. All traffic for devices associated with this default network identifier is forced to flow through the wireless switch. In other words, devices having the default network identifier are unable to carry out secure communication directly with mobile services system 118, wireless application server 122, or other components in wireless network 100. In a practical embodiment, the default network identifier is a specified ESSID (for example, ESSID number 101).

This example corresponds to an embodiment that employs a Layer 3 methodology (an equivalent process can be utilized for embodiments that employ a Layer 2 methodology). For this Layer 3 implementation, the wireless switch assigns a temporary IP address to the mobile computing device (task 408). In a practical deployment, the temporary IP address can be a 169.xxx.xxx.xxx address. If the mobile computing device supports the automatic provisioning technique, then it may instruct the wireless switch to operate as a load request proxy. Assuming that the wireless switch will function as a proxy for the mobile computing device, it will proceed to adopt the mobile computing device (task 410). This adoption procedure is akin to the adoption of a wireless access device by a wireless switch. In other words, the wireless switch will adopt the mobile computing device in a manner that enables the wireless switch to serve as a load request proxy for the mobile computing device. In accordance with one practical approach, adoption of the mobile computing device may utilize a specific or proprietary frame type for communication (which would make it recognizable only by certain types of equipment, e.g., equipment manufactured by a certain company or vendor). In connection with the adoption procedure, the wireless switch may provide a security token to the mobile computing device (task 412)—the security token, which is optional, is used by the mobility services agent on the mobile computing device to decrypt provisioning data. The security token may be provided to allow for the decryption of provisioned data.

Thereafter, the mobile computing device can generate a suitably formatted load request and send the load request to the wireless switch, which in turn receives and processes the load request (task 414). Notably, the use of the default ESSID (number 101) ensures that the load request will only reach the wireless switch. As mentioned above, the wireless switch functions as a load request proxy in this context. Accordingly, in response to the received load request, the wireless switch generates a suitably formatted proxy load request for the mobile computing device. The wireless switch sends the proxy load request to the mobile services system, which in turn receives and processes the proxy load request (task 416). The wireless switch can safely function as a proxy device in this respect because it is already a trusted component in the wireless network.

In response to the received proxy load request, the mobile services system obtains the provisioning data for the requesting mobile computing device (task 418). The provisioning data includes data that will be used to configure and setup the mobile computing device. For example, the provisioning data may include data that represents a secure network identifier (e.g., an ESSID) to be used by the mobile computing device in lieu of the default network identifier for subsequent communication with the wireless network. Alternatively or additionally, the provisioning data may include data that represents security settings to be used by the mobile computing device when accessing the wireless network. Alternatively or additionally, the provisioning data may include data that represents one or more software applications for the mobile computing device. Thereafter, the mobile services system sends the provisioning data in an appropriate format to the wireless switch, which in turn receives and processes the provisioning data (task 420).

In certain embodiments the wireless switch stores or maintains a copy of at least a portion of the provisioning data (task 422). This may be desirable for backup purposes and/or for purposes of tracking or monitoring the mobile computing devices throughout an enterprise network. For this Layer 3 implementation, the mobile computing device would then associate to the WLAN that was provisioned and then attain a new IP address (task 424). This new IP address, for example, a 157.xxx.xxx.xxx address, replaces the temporary IP address that was previously assigned. The wireless switch also sends the provisioning data to the mobile computing device, which in turn receives and processes the provisioning data (task 426). In practice, the provisioning data is transferred to the mobile computing device using the data communication link established during task 404 (i.e., either the wireless link from the access device or the wired link from the access device). In this manner, the wireless switch functions as a proxy to load the mobile computing device with its configuration/provisioning data.

The mobile computing device may save the provisioning data as needed (task 428) and proceed to configure itself with the provisioning data such that it can thereafter support compatible operation with the wireless network. For this example, the mobile computing device reboots itself after receiving the provisioning data, where the rebooting procedure causes the mobile computing device to configure itself with the necessary security settings, the replacement ESSID, software applications, and/or other provisioning data (task 430). The rebooting procedure may be automatically initiated upon receipt of the provisioning data, or it may be started in response to an operator command. Once loaded, the mobile computing device becomes the “decision-maker” rather than the wireless switch. Following task 430, the mobile computing device will be configured as a Layer 3 device, and provisioned for operation with the wireless network in a conventional manner. The default ESSID need not be active at this point because the mobile computing device will be using the replacement ESSID going forward. For example, the mobile computing device can now communicate with wireless application server 122 (see FIG. 1) in a secure manner, where such communication is not possible with genetic mobile computing devices that have not yet been provisioned.

The automatic provisioning methodology described above is suitable for use in a closed and secure wireless network, such as one maintained at a business facility, where only authorized mobile clients are given network access. In practice, the methodology enables compatible mobile client devices (e.g., devices having an appropriate mobility services agent installed) to be automatically provisioned in a quick, simple, and efficient manner. In contrast, incompatible mobile client devices will not be able to take advantage of the automatic provisioning technique; such devices may need to be provisioned using conventional techniques (such as preliminary bar coding), which may be more time consuming and cumbersome.

The automatic provisioning methodology described herein maintains the secure nature of the wireless network. If, for example, an unauthorized mobile computing device attempts to access the wireless network, it may be successful in reaching the wireless switch (due to the unsecured nature of this communication path). However, the unauthorized device will not have a compatible mobility services agent and, therefore, it will not be provided with the security token that is otherwise needed to proceed. Consequently, the unauthorized device will not be granted access to anything beyond the wireless switch.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for provisioning a mobile computing device for operation with a wireless network, the method comprising:
associating the mobile computing device with a wireless switch in the wireless network;
receiving a load request from the mobile computing device;
generating, in response to the load request, a proxy load request for the mobile computing device;
sending the proxy load request to a mobile services system in the wireless network;
receiving, in response to the proxy load request, provisioning data for the mobile computing device; and
sending the provisioning data to the mobile computing device.

2. A method according to claim 1, wherein the associating step uses a default network identifier that is orphaned in the wireless switch.

3. A method according to claim 2, wherein the default network identifier is a service set identifier.

4. A method according to claim 3, wherein the service set identifier is an extended service set identifier.

5. A method according to claim 2, wherein the provisioning data comprises data that represents a secure network identifier to be used by the mobile computing device, in lieu of the default network identifier, when accessing the wireless network.

6. A method according to claim 1, wherein sending the provisioning data initiates a rebooting of the mobile computing device.

7. A method according to claim 1, wherein the provisioning data comprises data that represents security settings to be used by the mobile computing device when accessing the wireless network.

8. A method according to claim 1, wherein the provisioning data comprises data that represents a software application for the mobile computing device.

9. A method according to claim 1, further comprising the wireless switch maintaining a copy of at least a portion of the provisioning data.

10. A method according to claim 1, wherein:
associating the mobile computing device with the wireless switch is initiated when the mobile computing device is coupled to the wireless network via a tangible data communication link; and
sending the provisioning data to the mobile computing device comprises sending the provisioning data via the tangible data communication link.

11. A method according to claim 1, wherein:
associating the mobile computing device with the wireless switch is initiated when the mobile computing device is coupled to the wireless network via a wireless data communication link; and
sending the provisioning data to the mobile computing device comprises sending the provisioning data via the wireless data communication link.

12. A wireless network device comprising:
a processing architecture;
a memory element coupled to the processing architecture; and
a communication module coupled to the processing architecture; wherein the processing architecture and the communication module are cooperatively configured to:
associate a mobile computing device in a wireless network with the wireless network device;
function as a provisioning data proxy between the mobile computing device and a mobile services system in the wireless network; and
send provisioning data obtained from the mobile services system to the mobile computing device in response to a load request that originates from the mobile computing device.

13. A wireless network device according to claim 12, wherein the processing architecture and the communication module are cooperatively configured to:
receive the load request from the mobile computing device;
generate, in response to the load request, a proxy load request for the mobile computing device;
send the proxy load request to the mobile services system;
receive, in response to the proxy load request, the provisioning data for the mobile computing device.

14. A wireless network device according to claim 12, wherein the processing architecture and the communication module associate the mobile computing device with the wireless network device using a default service set identifier that is orphaned in the wireless network device.

15. A wireless network device according to claim 14, wherein the provisioning data comprises data that represents a secure network identifier to be used by the mobile computing device, in lieu of the default service set identifier, when accessing the wireless network.

16. A wireless network device according to claim 12, wherein the provisioning data comprises data that represents security settings to be used by the mobile computing device when accessing the wireless network.

17. A wireless network device according to claim 12, wherein the provisioning data comprises data that represents a software application for the mobile computing device.

18. A wireless network device according to claim 12, wherein the memory element is configured to store a copy of at least a portion of the provisioning data.

19. A wireless network architecture comprising:
a network infrastructure;
a wireless switch coupled to the network infrastructure;
a mobile services system coupled to the network infrastructure; and
a mobile computing device configured to associate with the wireless switch using a default network identifier that is orphaned in the wireless switch, and to send a load request to the wireless switch upon initialization; wherein
the wireless switch is configured to receive the load request, and to send, in response to the load request, a proxy load request to the mobile services system;
the mobile services system is configured to provide, in response to the proxy load request, provisioning data for the mobile computing device; and
the wireless switch is configured to receive the provisioning data from the mobile services system, and to send the provisioning data to the mobile computing device.

20. A wireless network architecture according to claim 19, wherein the mobile computing device is configured to receive the provisioning data from the wireless switch, and to provision itself for operation with a wireless network that includes the wireless switch.

21. A wireless network architecture according to claim 19, wherein the default network identifier is a service set identifier.

22. A wireless network architecture according to claim 19, wherein the mobile computing device is configured to receive the provisioning data from the wireless switch, and to reboot itself with the provisioning data.

23. A wireless network architecture according to claim 19, wherein the provisioning data comprises data that represents security settings to be used by the mobile computing device when accessing the wireless network.

24. A wireless network architecture according to claim 19, wherein the provisioning data comprises data that represents a secure network identifier to be used by the mobile computing device, in lieu of the default network identifier, when accessing the wireless network.

25. A wireless network architecture according to claim 19, wherein the provisioning data comprises data that represents a software application for the mobile computing device.

26. A wireless network architecture according to claim 19, wherein the mobile computing device comprises a network communication module configured to send the load request to the network infrastructure via a tangible data communication link, and to receive the provisioning data from the network infrastructure via the tangible data communication link.

27. A wireless network architecture according to claim 19, wherein the mobile computing device comprises a wireless communication module configured to send the load request to the network infrastructure via a wireless data communication link, and to receive the provisioning data from the network infrastructure via the wireless data communication link.

28. A method for provisioning a mobile computing device for operation with a wireless network, the method comprising:
associating the mobile computing device with a wireless switch in the wireless network, using a default network identifier that is orphaned in the wireless switch;
the mobile computing device sending a load request to the wireless switch;
the mobile computing device receiving, in response to the load request, provisioning data from the wireless switch; and
the mobile computing device configuring itself with the provisioning data for operation with the wireless network.

29. A method according to claim 28, wherein the default network identifier is a service set identifier.

30. A method according to claim 28, further comprising rebooting the mobile computing device after receiving the provisioning data, wherein the configuring step is initiated by the rebooting step.

31. A method according to claim 28, wherein the provisioning data comprises data that represents security settings to be used by the mobile computing device when accessing the wireless network.

32. A method according to claim 28, wherein the provisioning data comprises data that represents a secure network identifier to be used by the mobile computing device, in lieu of the default network identifier, when accessing the wireless network.

33. A method according to claim 28, wherein the provisioning data comprises data that represents a software application for the mobile computing device.
